(19) United States
(12) Patent Application Publication
(10) Pub. No.: US 2023/0339619 A1
(43) Pub. Date: Oct. 26, 2023

(54) ELECTRIC POWER SYSTEM OF MOVING OBJECT

(71) Applicant: HONDA MOTOR CO., LTD., Tokyo (JP)

(72) Inventors: Koji Hosono, Wako-shi (JP); Akinori Kita, Wako-shi (JP); Masashi Eto, Wako-shi (JP)

(21) Appl. No.: 18/303,783

(22) Filed: Apr. 20, 2023

(30) Foreign Application Priority Data
Apr. 22, 2022 (JP) 2022-070554

(51) Int. Cl. B64D 27/24; B60L 53/20; B60L 53/16

(52) U.S. Cl. CPC B64D 27/24; B60L 53/16; B60L 53/20; B60L 2200/10; B64D 2221/00

(57) ABSTRACT

An electric power system of a moving object includes: a low-voltage device that operates with low-voltage power; a high-voltage device that operates with high-voltage power; a power supply port to which a connector of an external power source is connected; and a transformer capable of transforming electric power supplied from the external power source via the power supply port and supplying the transformed electric power to the low-voltage device or the high-voltage device.

### CROSS-REFERENCE TO RELATED APPLICATIONS

This application is based upon and claims the benefit of priority from Japanese Patent Application No. 2022-070554 filed on Apr. 22, 2022, the contents of which are incorporated herein by reference.

### BACKGROUND OF THE INVENTION

### Field of the Invention

The present invention relates to an electric power system of a moving object including a low-voltage device and a high-voltage device.

### Description of the Related Art

At present, motorization of moving objects (vehicles, aircraft, ships, and the like) is progressing. JP 2020-182372 A discloses an electric aircraft. The electric aircraft includes a generator, a high-voltage battery, a plurality of loads, and a rectifying unit. The plurality of loads include a plurality of high-voltage devices and a plurality of low-voltage devices. The rectifying unit can transform (step down) the electric power of the high-voltage battery and supply the transformed electric power to the plurality of low-voltage loads.

### SUMMARY OF THE INVENTION

In recent years, it has been desired to supply electric power from an external power source to each load in a stopped electric moving object. However, JP 2020-182372 A does not disclose a power supply path from an external power source to each load.

An object of the present invention is to solve the above-mentioned problem.

According to an aspect of the present invention, there is provided an electric power system of a moving object, the electric power system comprising: a low-voltage device configured to operate with low-voltage power; a high-voltage device configured to operate with high-voltage power; a power supply port to which a connector of an external power source is connected; and a transformer configured to transform electric power supplied from the external power source via the power supply port, and supply the transformed electric power to the low-voltage device or the high-voltage device.

According to the present invention, electric power can be supplied from the external power source to the low-voltage device and the high-voltage device. In addition, according to the present invention, since electric power can be supplied to the low-voltage device and the high-voltage device via only one power supply port, the electric power system can be simplified.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a top view of an aircraft;

FIG. 2 is a block diagram showing a configuration of an electric power system;

FIG. 3 is a diagram showing a transmission state of electric power when an engine is started;

FIG. 4 is a diagram showing a transmission state of electric power in a state where a high-voltage battery is charged; and

FIG. 5 is a diagram showing a transmission state of electric power when the aircraft is in flight.

### DETAILED DESCRIPTION OF THE INVENTION

### 1. Configuration of Aircraft 10

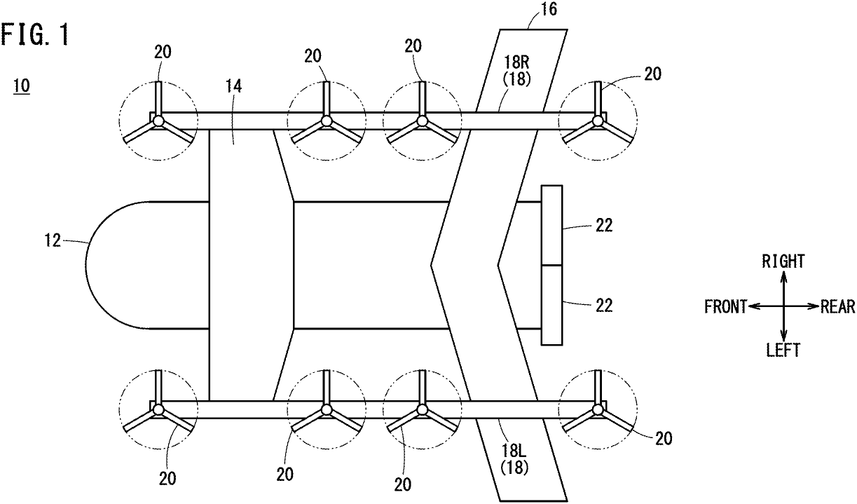

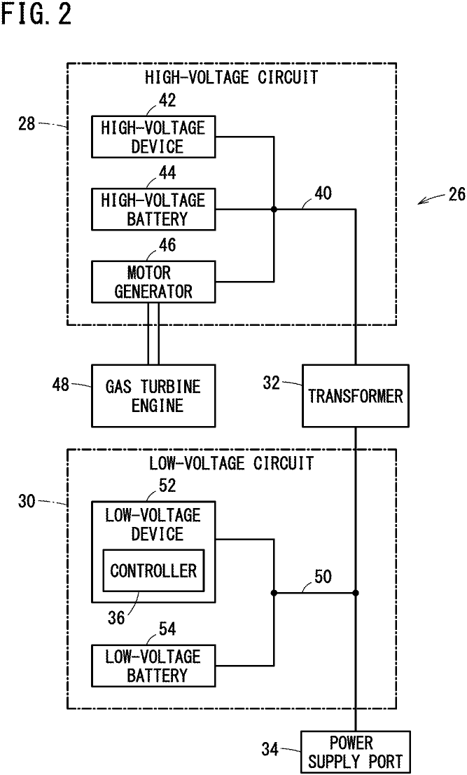

FIG. 1 is a top view of an aircraft 10. The aircraft 10 is an electric aircraft, for example, an electric vertical take-off and landing aircraft (eVTOL aircraft). Furthermore, the aircraft 10 is a hybrid aircraft including a high-voltage battery 44 and a motor generator 46 (FIG. 2) as power sources for flight.

The aircraft 10 includes a fuselage 12, a front wing 14, a rear wing 16, two booms 18, eight VTOL rotors 20, and two cruise rotors 22. In addition, the aircraft 10 includes an electric power system 26 shown in FIG. 2.

The front wing 14 is connected to a front portion of the fuselage 12. The rear wing 16 is connected to a rear portion of the fuselage 12. The front wing 14 and the rear wing 16 generate lift when the aircraft 10 moves forward.

A boom 18R of the two booms 18 is disposed on the right side of the fuselage 12. A boom 18L of the two booms 18 is disposed on the left side of the fuselage 12. Each boom 18 extends in the front-rear direction.

Four motors (high-voltage devices 42 in FIG. 2) are arranged on the boom 18R in order from the front to the rear. Similarly, four motors (the high-voltage devices 42 in FIG. 2) are arranged on the boom 18L in order from the front to the rear. The rotation shaft of each motor is connected to the VTOL rotor 20 corresponding to the motor. Each VTOL rotor 20 is used during vertical take-off, during transition from vertical take-off to cruising, during transition from cruising to vertical landing, during vertical landing, and during hovering of the aircraft 10. Each VTOL rotor 20 generates lift by rotating.

Two or more motors (the high-voltage devices 42 in FIG. 2) are disposed in the fuselage 12. The rotation shaft of each motor is connected to the cruise rotor 22 corresponding to the motor. Each cruise rotor 22 is used during cruising, during transition from vertical take-off to cruising, and during transition from cruising to vertical landing of the aircraft 10. Each cruise rotor 22 generates thrust by rotating.

### 2. Configuration of Electric Power System 26

FIG. 2 is a block diagram showing a configuration of the electric power system 26. The electric power system 26 includes a high-voltage circuit 28, a low-voltage circuit 30, a transformer 32, and a power supply port 34. The electric power system 26 also includes a controller 36.

The high-voltage circuit 28 includes a high-voltage bus 40 serving as a transmission path of high-voltage power, and a plurality of electric devices that use high-voltage power. The voltage of the high-voltage power used in the aircraft 10 is, for example, several hundreds [V]. The plurality of electric devices of the high-voltage circuit 28 include one or more high-voltage devices 42, one or more high-voltage batteries 44, and the motor generator 46. The high-voltage device 42 is a load that operates with high-voltage power. Examples of the high-voltage device 42 include various motors (motors coupled to the VTOL rotors 20, motors coupled to the cruise rotors 22, and the like). The high-voltage battery 44 can be charged with and discharge high-voltage power. The motor generator 46 is a generator that generates high-voltage power by rotating a power generation body using power of a gas turbine engine 48 (also referred to as an engine 48). The motor generator 46 is also a starter motor that starts the engine 48 by rotating the rotation shaft with high-voltage power.

The high-voltage bus 40 is provided with a plurality of electric devices (not shown) such as a converter, an inverter, and a switch. Some of the electric devices control electric power supplied to the high-voltage devices 42. The electric power control referred to in the specification includes AC-DC conversion, DC-AC conversion, and connection and disconnection of a power transmission path. Some of the electric devices control electric power supplied to the high-voltage battery 44 or the motor generator 46, and control electric power supplied from the high-voltage battery 44 or the motor generator 46. Each electric device operates in response to an operation signal output from the controller 36.

The low-voltage circuit 30 includes a low-voltage bus 50 serving as a transmission path of low-voltage power, and a plurality of electric devices that use low-voltage power. The voltage of the low-voltage power used in the aircraft 10 is, for example, about several tens [V]. The plurality of electric devices of the low-voltage circuit 30 include one or more low-voltage devices 52, and one or more low-voltage batteries 54. The low-voltage device 52 is a load that operates with low-voltage power. Examples of the low-voltage device 52 include avionics, various lighting devices, various electric pumps, and the controller 36. The low-voltage battery 54 can be charged with and discharge low-voltage power.

The low-voltage bus 50 is provided with a plurality of electric devices (not shown) such as a converter, an inverter, and a switch. Some of the electric devices control electric power supplied to the low-voltage device 52. Some of the electric devices control electric power supplied to the low-voltage battery 54 and control electric power supplied from the low-voltage battery 54. Each electric device operates in response to an operation signal output from the controller 36. Note that some of the low-voltage devices 52 may be connected to the power supply port 34 directly or via only a switch.

The transformer 32 is interposed between the high-voltage circuit 28 and the low-voltage circuit 30, and is connected to the high-voltage bus 40 and the low-voltage bus 50. The transformer 32 is a step-up/step-down converter capable of converting high-voltage power into low-voltage power, and converting low-voltage power into high-voltage power. That is, the transformer 32 can step up the low-voltage power supplied from the low-voltage circuit 30 to high-voltage power by operation of one or more switching elements (not shown), and output the high-voltage power to the high-voltage circuit 28. In addition, the transformer 32 can step down the high-voltage power supplied from the high-voltage circuit 28 to low-voltage power by operation of one or more switching elements, and output the low-voltage power to the low-voltage circuit 30. The one or more switching elements operate in response to operation signals output from the controller 36.

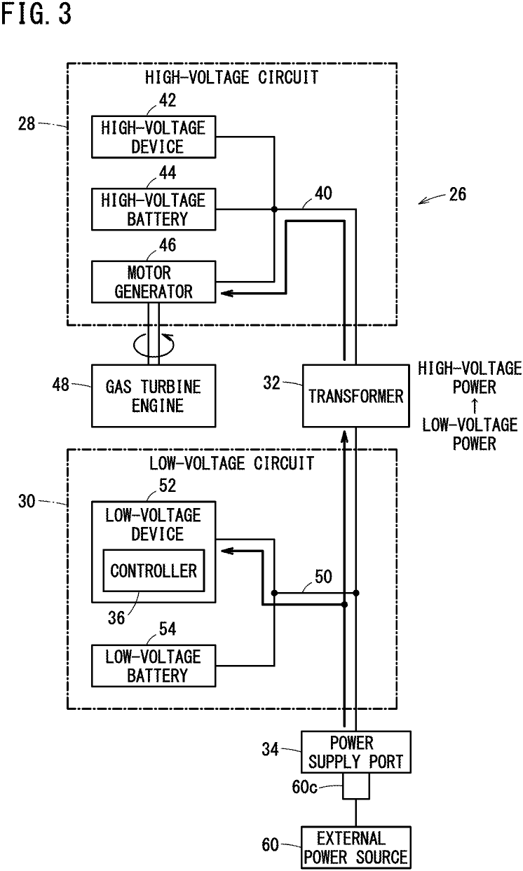

The power supply port 34 is provided, for example, in an outer peripheral portion of the aircraft 10. The power supply port 34 is a power receiving connector. The power supply port 34 is connected to the low-voltage bus 50. A power supply connector 60c (FIG. 3 and the like) of an external power source 60 (FIG. 3 and the like) is attachable to and detachable from the power supply port 34. The electric power system 26 can receive low-voltage power from the external power source 60 via the power supply port 34. The external power source 60 may be an AC power source or a DC power source.

The controller 36 is a computer such as an ECU. The controller 36 may be a flight controller of the aircraft 10, or may be a controller other than a flight controller. The controller 36 includes processing circuitry and a memory. The processing circuitry may be a processor such as a CPU. The processing circuitry may be an integrated circuit such as an ASIC or an FPGA. The processor can execute various processes by executing programs stored in the memory. For example, the processing circuitry executes a program to control each switching element of the electric power system 26. At least some of the plurality of processes may be executed by an electronic circuit including a discrete device.

The memory includes a volatile memory and a non-volatile memory. Examples of the volatile memory include a RAM and the like. The volatile memory is used as a working memory of the processor. The volatile memory temporarily stores data and the like necessary for processing or computation. Examples of the non-volatile memory include a ROM, a flash memory, and the like. The non-volatile memory is used as a storage memory. The non-volatile memory stores programs, tables, maps, and the like. At least a part of the memory may be included in the processor, the integrated circuit, or the like described above.

### 3. Specific Example of Power Supply in Electric Power System 26

The high-voltage device 42 can operate using high-voltage power supplied from the high-voltage battery 44 and high-voltage power supplied from the motor generator 46. The motor generator 46 can operate using the high-voltage power supplied from the high-voltage battery 44. The high-voltage battery 44 can be charged using the high-voltage power supplied from the motor generator 46.

Furthermore, the high-voltage device 42 and the motor generator 46 can operate using low-voltage power supplied from the low-voltage battery 54 and low-voltage power supplied from the external power source 60. The high-voltage battery 44 can be charged using the low-voltage power supplied from the low-voltage battery 54 and the low-voltage power supplied from the external power source 60. When electric power is supplied from one of the low-voltage battery 54 or the external power source 60 to the high-voltage device 42, the motor generator 46, or the high-voltage battery 44, the transformer 32 steps up the low-voltage power to high-voltage power, and outputs the high-voltage power to the high-voltage bus 40.

The low-voltage device 52 can operate using the low-voltage power supplied from the low-voltage battery 54 and the low-voltage power supplied from the external power source 60. The low-voltage battery 54 can be charged using the low-voltage power supplied from the external power source 60.

Furthermore, the low-voltage device 52 can operate using the high-voltage power supplied from the high-voltage battery 44 and the high-voltage power supplied from the motor generator 46. The low-voltage battery 54 can be charged using the high-voltage power supplied from the high-voltage battery 44 and the high-voltage power supplied from the motor generator 46. When electric power is supplied from one of the high-voltage battery 44 or the motor generator 46 to the low-voltage device 52 or the low-voltage battery 54, the transformer 32 steps down the high-voltage power to low-voltage power, and outputs the low-voltage power to the low-voltage bus 50.

Hereinafter, examples of power supply in the electric power system 26 will be described for each situation.

### 1. Power Supply Example When Engine 48 Is Started]

FIG. 3 is a diagram showing a transmission state of electric power when the engine 48 is started. The engine 48 can be started using electric power supplied from the external power source 60. When the engine 48 is started using the electric power supplied from the external power source 60, the electric power is transmitted along paths indicated by arrows in FIG. 3.

When the power supply connector 60c of the external power source 60 is connected to the power supply port 34, low-voltage power is supplied from the external power source 60 to the low-voltage bus 50. A user operates a start switch to start the engine 48. The start switch is provided, for example, in a cockpit. The controller 36 controls the switching elements of the transformer 32 in response to the operation of the start switch. The transformer 32 steps up the low-voltage power of the low-voltage bus 50 to high-voltage power. Then, the high-voltage power is output from the transformer 32 to the high-voltage bus 40. Further, the controller 36 controls the electric devices (not shown) such as the inverter and the converter provided on the high-voltage bus 40, to supply high-voltage power to the motor generator 46. As a result, the motor generator 46 functions as a starter motor and starts the engine 48. After the engine 48 is started, the motor generator 46 functions as a generator.

Various low-voltage devices 52 (such as a water pump, an oil pump, and an air pump) related to the operation of the motor generator 46 are connected to the low-voltage bus 50. Various low-voltage devices 52 (such as a fuel pump) related to the operation of the engine 48 are also connected to the low-voltage bus 50. Further, the controller 36 is connected to the low-voltage bus 50. The controller 36 controls the electric devices (not shown) such as the inverter, the converter, and the switch provided on the low-voltage bus 50, to supply low-voltage power to each low-voltage device 52.

### 2. Power Supply Example When High-Voltage Battery 44 is Charged]

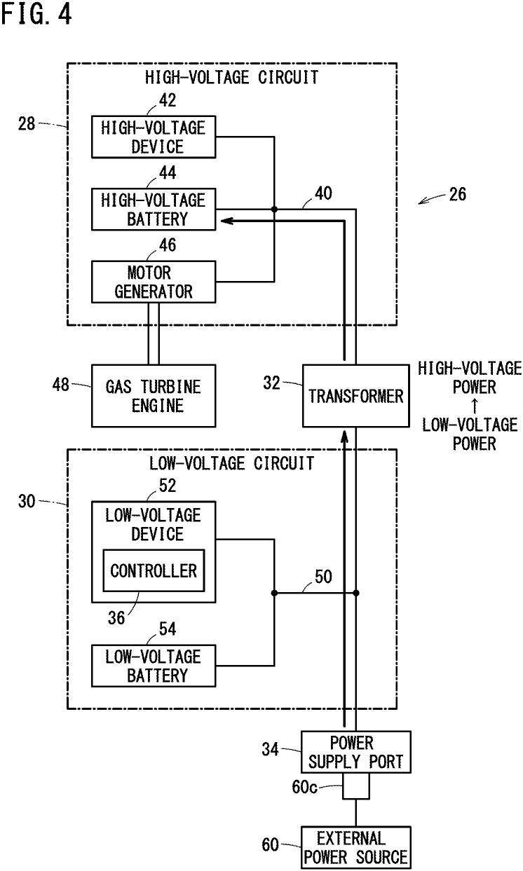

FIG. 4 is a diagram showing a transmission state of electric power in a state where the high-voltage battery 44 is charged. As described above, the high-voltage battery 44 can be charged using the electric power supplied from the external power source 60. When the high-voltage battery 44 is charged using the electric power supplied from the external power source 60, the electric power is transmitted along a path indicated by an arrow in FIG. 4.

When the power supply connector 60c of the external power source 60 is connected to the power supply port 34, low-voltage power is supplied from the external power source 60 to the low-voltage bus 50. The user operates a charging switch to charge the high-voltage battery 44. The charging switch is provided, for example, in the cockpit. The controller 36 controls the switching elements of the transformer 32 in response to the operation of the charging switch. The transformer 32 steps up the low-voltage power of the low-voltage bus 50 to high-voltage power. Then, the high-voltage power is output from the transformer 32 to the high-voltage bus 40. In addition, the controller 36 connects a contactor (not shown) disposed between the transformer 32 and the high-voltage battery 44, to supply high-voltage power to the high-voltage battery 44.

### 3. Power Supply Example When Aircraft 10 Is in Flight]

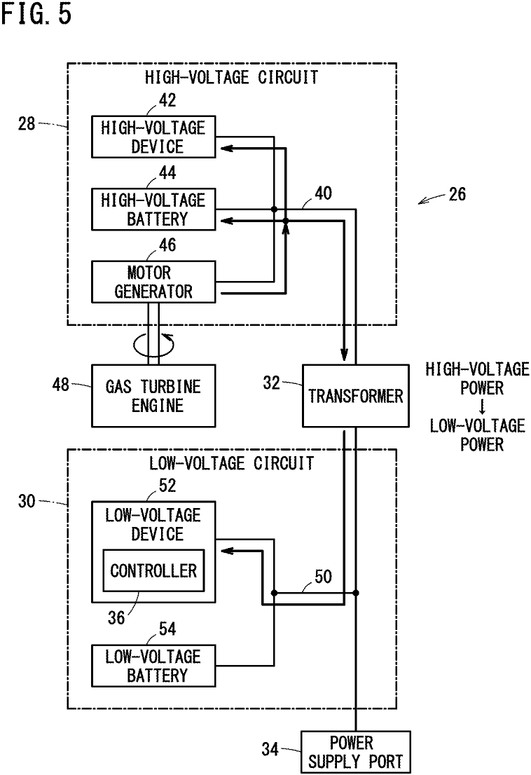

FIG. 5 is a diagram showing a transmission state of electric power when the aircraft 10 is in flight. The respective loads (the high-voltage devices 42 and the low-voltage devices 52) of the electric power system 26 can operate using electric power generated by the motor generator 46. When the respective loads are operated using the electric power generated by the motor generator 46, the electric power is transmitted along paths indicated by arrows in FIG. 5.

The electric power generated by the motor generator 46 during flight of the aircraft 10 is used as a power source for each load. Further, during flight of the aircraft 10, the high-voltage battery 44 and the low-voltage battery 54 are used as auxiliary power sources for each load.

The controller 36 controls the devices (not shown) such as the inverter and the converter provided on the high-voltage bus 40, to supply the high-voltage power generated by the motor generator 46 to each of the high-voltage devices 42. Further, the controller 36 controls the switching elements of the transformer 32. The transformer 32 steps down the high-voltage power of the high-voltage bus 40 to low-voltage power. Then, the low-voltage power is output from the transformer 32 to the low-voltage bus 50. Furthermore, the controller 36 controls the devices (not shown) such as the inverter, the converter, and the switch provided on the low-voltage bus 50, to supply the low-voltage power to each of the low-voltage devices 52.

The electric power system 26 may be provided not only in the aircraft 10 but also in other moving objects, for example, an electric vehicle (an electric automobile, a plug-in hybrid automobile, an electric motorcycle, or the like), an electric ship, or the like.

### 4. Other Embodiment

The above-described embodiment relates to the electric power system 26 connectable to the external power source 60 that supplies low-voltage power. However, the electric power system 26 may be connected to an external power source 60 that supplies high-voltage power. In this case, the position of the high-voltage circuit 28 and the position of the low-voltage circuit 30 are switched in FIGS. 2 to 5. That is, the high-voltage circuit 28 is directly connected to the power supply port 34. On the other hand, the low-voltage circuit 30 is connected to the power supply port 34 via the transformer 32.

### 5. Invention Obtained From Embodiments

The invention that can be grasped from the above embodiments will be described below.

According to an aspect of the present invention, provided is the electric power system (26) of the moving object, the electric power system including: the low-voltage device (52) configured to operate with low-voltage power; the high-voltage device (42) configured to operate with high-voltage power; the power supply port (34) to which the connector (60c) of the external power source (60) is connected; and the transformer (32) configured to transform electric power supplied from the external power source via the power supply port, and supply the transformed electric power to the low-voltage device or the high-voltage device.

According to the above configuration, electric power can be supplied from the external power source to the low-voltage device and the high-voltage device. In addition, according to the above configuration, since electric power can be supplied to the low-voltage device and the high-voltage device via only one power supply port, the electric power system can be simplified.

In the aspect of the present invention, the transformer may step up low-voltage power supplied from the external power source via the power supply port to high-voltage power.

According to the above configuration, since the external power source can serve as a power source that supplies low-voltage power, it is possible to suppress the cost for maintaining the external power source.

In the aspect of the present invention, the low-voltage device may operate with the low-voltage power supplied from the external power source via the power supply port, and the high-voltage device may operate with the high-voltage power stepped up by the transformer.

According to the above configuration, since a power converter is not required between the power supply port and the low-voltage device, the electric power system can be further simplified.

In the aspect of the present invention, the transformer may step down the high-voltage power supplied from the external power source via the power supply port to low-voltage power.

In the aspect of the present invention, the low-voltage device may operate with the low-voltage power stepped down by the transformer, and the high-voltage device may operate with the low-voltage power supplied from the external power source via the power supply port.

The electric power system of the moving object according to the aspect of the present invention may further include the generator (46) configured to generate high-voltage power, and the transformer may step down the high-voltage power generated by the generator to low-voltage power, and supply the low-voltage power to the low-voltage device.

According to the above configuration, it is possible to make the power source redundant.

The electric power system of the moving object according to the aspect of the present invention may further include the low-voltage battery (54) configured to supply low-voltage power, and the transformer may step up the low-voltage power supplied from the low-voltage battery to high-voltage power, and supply the high-voltage power to the high-voltage device.

According to the above configuration, it is possible to make the power source redundant.

The electric power system of the moving object according to the aspect of the present invention may further include the high-voltage battery (44) configured to supply high-voltage power, and the transformer may step down the high-voltage power supplied from the high-voltage battery to low-voltage power, and supply the low-voltage power to the low-voltage device.

According to the above configuration, it is possible to make the power source redundant.

The electric power system of the moving object according to the aspect of the present invention may be provided in the aircraft (10).

The present invention is not limited to the above disclosure, and various modifications are possible without departing from the essence and gist of the present invention.

1. An electric power system of a moving object, the electric power system comprising:
a low-voltage device configured to operate with low-voltage power;
a high-voltage device configured to operate with high-voltage power;
a power supply port to which a connector of an external power source is connected; and
a transformer configured to transform electric power supplied from the external power source via the power supply port, and supply the transformed electric power to the low-voltage device or the high-voltage device.

2. The electric power system of the moving object according to claim 1, wherein
the transformer steps up low-voltage power supplied from the external power source via the power supply port to high-voltage power.

3. The electric power system of the moving object according to claim 2, wherein
the low-voltage device operates with the low-voltage power supplied from the external power source via the power supply port, and
the high-voltage device operates with the high-voltage power stepped up by the transformer.

4. The electric power system of the moving object according to claim 1, wherein
the transformer steps down high-voltage power supplied from the external power source via the power supply port to low-voltage power.

5. The electric power system of the moving object according to claim 4, wherein
the low-voltage device operates with the low-voltage power stepped down by the transformer, and
the high-voltage device operates with low-voltage power supplied from the external power source via the power supply port.

6. The electric power system of the moving object according to claim 1, further comprising a generator configured to generate high-voltage power, wherein
the transformer is configured to step down the high-voltage power generated by the generator to low-voltage power, and supply the low-voltage power to the low-voltage device.

7. The electric power system of the moving object according to claim 1, further comprising a low-voltage battery configured to supply low-voltage power, wherein
the transformer is configured to step up the low-voltage power supplied from the low-voltage battery to high-voltage power, and supply the high-voltage power to the high-voltage device.

8. The electric power system of the moving object according to claim 1, further comprising a high-voltage battery configured to supply high-voltage power, wherein
the transformer is configured to step down the high-voltage power supplied from the high-voltage battery to low-voltage power, and supply the low-voltage power to the low-voltage device.

9. The electric power system of the moving object according to claim 1, wherein
the electric power system is provided in an aircraft.
